(19) United States
(12) Patent Application Publication
(10) Pub. No.: US 2005/0171781 A1
(43) Pub. Date: Aug. 4, 2005

(54) Speech information system

(76) Inventor: Jon M. Poploskie, Madison Hts., MI (US)

Correspondence Address: RAGGIO & DINNIN, P.C., 2701 CAMBRIDGE COURT, STE. 500, AUBURN HILLS, MI, 48326, US

(21) Appl. No.: 11/031,359

(22) Filed: Jan. 6, 2005

Related U.S. Application Data
(60) Provisional application No. 60/534,906, filed on Jan. 8, 2004.

(51) Int. Cl. G10L 11/00

(52) U.S. Cl. 704/270.1

(57) ABSTRACT

A method of controlling a speech based communication system. The method will initialize the system and poll a server for data or data sources. The method requests a new call through a telephony coordinator and connects the new call with a speech server. The method enables the speech server to conduct the call and transfer information therefrom to at least one other server. The method will also disconnect the call and determine if any other new calls are pending.

Continuation of Provisional Application Ser. No. 60/534,906—Filed: Jan. 8, 2004

### BACKGROUND OF THE INVENTION

1. Field of the Invention

This invention will broadly relate to speech information systems, and more particularly relate to a speech information communication system for use by a business in dealing with customer service.

2. Description of Related Art

Speech recognition systems are well known in the art. One prior art version of speech recognition systems is a single user and speaker dependent. This requires each speaker to train the speech recognizer with his or her voice patterns during a process called enrollment. These systems will maintain a profile for each speaker who must identify themselves to the system in future sessions. Typically, speakers enroll via a local microphone in a low noise environment and speak into a single machine on which the recognizer is resident.

Other prior art speech recognition systems are both speaker independent and capable of recognizing words from a continuous stream of conversational speech. These prior art systems require no individualized speaker enrollment prior to effective use. With the continuous speech recognition no pauses between words are required, thus the systems represent a much more user friendly approach to the casual user of a speech recognition system. These types of systems are essential features of telephonic speech recognition systems, since the user will have no training in how to adjust their speech for the benefit of the recognizer. Many of these prior art speech recognition systems also offer real time operation with a given predetermined vocabulary. Many are also able to recognize speech patterns in high noise environments and the like. Many of these prior art systems also enable a plurality of voice applications to be recognized by a speech recognizer concurrently in a computer network or telephonically.

Many of these prior art speech recognition systems also are capable of providing the user who is away from his or her personal computer information such as calendar events, or electronic mail messages via speech. The text is extracted from data files in accordance with selections made remotely. These systems generally will extract the selected portion of the usable text and label. Then the text and the generated labels are output to a text to speech converter for converting the text to speech. Therefore, the personal computer user could use a telephone to contact a personal computer and in accordance with entered selections the user can hear calendar appointments, electronic messages and other information stored in the structured data files.

However, many of these prior art systems were slow to respond and had difficultly recognizing spoken speech in small time frames such as those needed in the current business environment. Most of these prior art systems were used for individuals to contact a specific computer to retrieve such information, text the user wanted to retrieve via a speech recognition system. There were also problems with the connectivity between the speech recognition system and the text to speech converters which were necessary to convert written text files into speech through the speech recognition systems in order to relay such messages to the user via phone or other communication links.

Therefore, there is a need in the art for a speech recognition system that is capable of operating in customer service situations such as answering incoming calls, notification, customer mining and setting appointments along with other business needs that businesses have who have very high customer contact and customer service issues.

There also is a need in the art for a low cost, high efficiency system that will increase the productivity of employees by freeing them from general telephone tasks such as answering and transferring incoming calls, appointments, rescheduling and other easily retrievable data via a computer and speech recognition system unit.

### SUMMARY OF THE INVENTION

One object of the present invention is to provide a low cost, high efficiency speech recognition communication system for use in a business environment.

Another object of the present invention is to provide a communication system for a business that has high customer contact with numerous customer service issues.

Still another object of the present invention is to provide a communication system to handle incoming phone calls and quickly and easily transfer callers to the person or department that they wish to speak with via speech recognition.

Still another object of the present invention is to provide a communication system that has all communication completed within the system via speech recognition eliminating the need for touch tone.

Still another object of the present invention is to provide a communication system that interacts with various business management software systems to gather information on who to call and when such calls should happen.

Still another object of the present invention is to provide a communication system for businesses that occurs in real time and offers high tech functionality.

Yet another object of the present invention is to provide a communication system that lowers the business costs by being able to configure the system one time with a set of business specific parameters and then have the system automatically interact with the existing business system architecture to retrieve the appropriate call lists, automatically call them, etc.

It is still another object of the present invention to provide a communication system that provides for ease of use to customers via speech recognition systems.

Still another object of the present invention is to provide a communication system that is easy to maintain, adjust and operate.

According to the present invention, the foregoing and other objects and advantages are obtained by a novel business communication system that is completely speech enabled. The business communication system will allow employees and/or customers to quickly and easily retrieve business information over the phone from remote locations. Users will be able to call into the system using any phone and communicate via speech to receive critical business information or other information so designated by the business. The speech recognition will provide a simple and effective means to interact with customers and employees all in a real time mode with increased functionality, data retrieval and storage abilities.

### BRIEF DESCRIPTION OF THE DRAWINGS

FIG. 1 shows an overall architecture of the communication system according to the present invention.

FIG. 2 shows the main logical components and application overview of the communication system according to the present invention.

FIG. 3 shows a high level outbound call flow according to the present invention.

FIGS. 4A-B show a sample call flow for a communication system according to the present invention.

FIG. 5 shows an auto attendant call flow chart according to the present invention.

### DESCRIPTION OF THE PREFERRED EMBODIMENT(S) AND BEST MODE FOR CARRYING OUT THE INVENTION

The business communication or notification system according to the present invention is for use in handling incoming calls, and for contacting both customers and employees regarding business information, such as schedules, appointments, and the like. This type of communication system will be completely speech recognition enabled. This speech information system is tailored to provide ready to use application framework that users may use with their existing documents and reports. The system would be speech enabled and allow the users to speak commands to the system before or after an authentication process occurs. The user will be prompted for various reports and the like and the user would then via speech select the report to be reviewed and then a text to speech converter would convert the text of the report into speech such that the user can listen to any record, appointments, emails, or business documents on the appropriate network in real time in the language of their choice. The architecture used for the communication system will reduce costs while also allowing ease of operation and maintenance when necessary by the business being used.

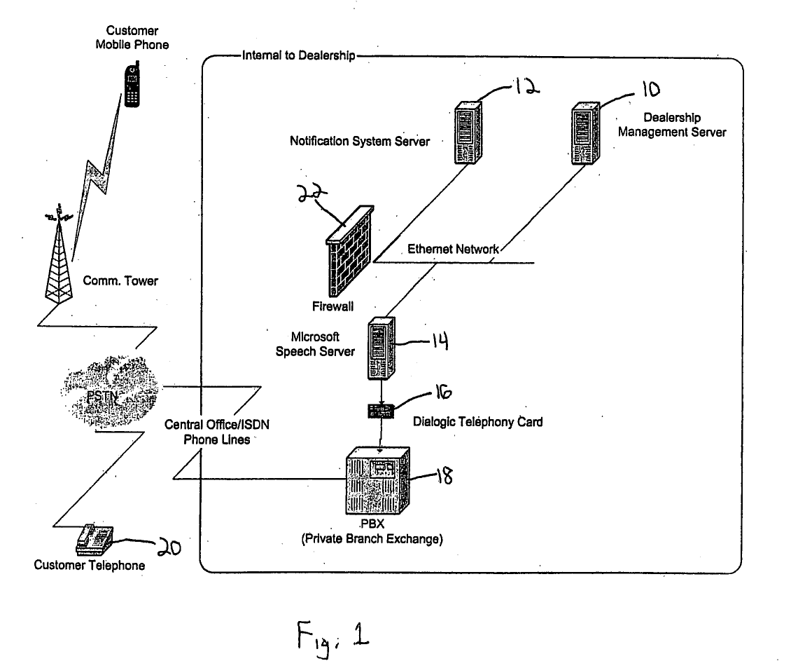

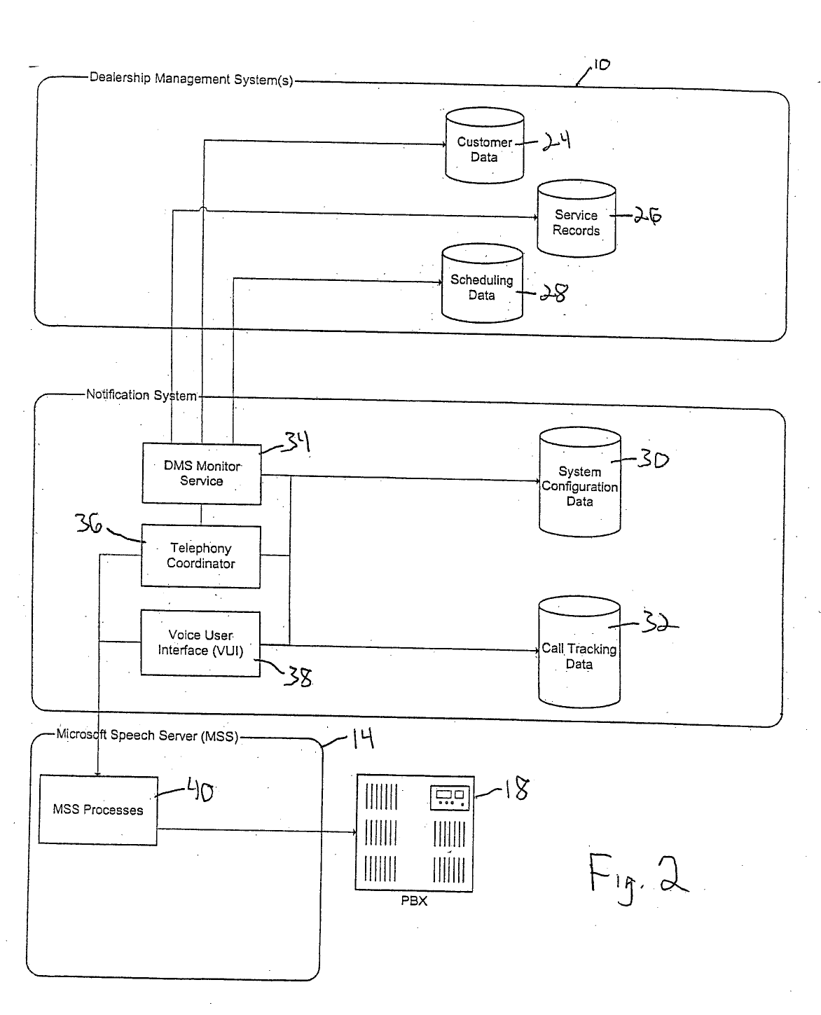

The communication system is capable of being used for any type of business that relies heavily on customer service to attract and retain customers. Therefore, any of the modem day business companies are capable of using the communication system at some level. The figures show a specific example for use with a dealership. This dealership communication system 11 will be described with reference to FIGS. 1 through 4. However, please note that any other type of business other than an automotive dealership may also use the communication system within their business, customer, employee and supplier needs.

Generally, dealerships rely heavily on customer service to attract and retain customers. Many automotive dealerships use customer service as their primary means of ensuring that customers will buy from and have all vehicle service done by them in the future and also as a major means of income and profit for the dealerships. Pricing and demand is generally controlled by the manufacturers due to increased use of incentives and other customer attraction programs to lure customers to buy specific vehicles. Many of these dealerships are looking for ways to improve and measure customer satisfaction. One such way to improve customer satisfaction is through the use of the current present invention of a dealership communication system 11. However, any other type of business may also use the notification/communication system and the use at a dealership is only one type of application and in no way limits the present invention from being used in any other known business or business application. The dealership communication system 11 will allow the dealerships to automatically contact customers with regards to appointments such as reminding them, notifying them of missed appointments or advising them of recall campaigns while also conducting customer satisfaction surveys if necessary. It is also contemplated to use a dealership communication system to increase revenues by using mining calls, touching base with customers that have not been in contact with the dealership in a predetermined amount of time. The dealership communication system 11 provides numerous advantages over the prior art systems. The main is that is uses speech recognition to provide a simple and effective means to interact with customers, suppliers and employees. All the communication within the dealership communication system 11 is done via speech recognition thus eliminating the need to use touch tone phones and entering specific key strokes on the phone to reply to questions or the like. Many of the prior art systems that use touch tone phones are found to be cumbersome and annoying by many of the users of these systems. The dealership communication system 11 of the present invention also will interact with the dealers management software systems to gather information on the people to be called and when such calls should take place for best effect. The dealership communication system 11 may or may not operate in real time which offers a major advantage over batch systems which can only get point in time information, potentially limiting their functionality within today's global business environment.

The advantages of the dealership communication system 11 are numerous over the prior art systems or specific methods dealerships used in the past to conduct such customer service business. Generally, prior art systems include touch tone phone systems or actual dealership employees to handling incoming calls and to make phone calls to remind about appointments, recalls, etc. Some of the advantages for dealerships upon use of the system 11 will be increased sales, cost reduction and improved customer satisfaction. The dealership can increase sales by reaching out to customers that the dealership has not seen recently or whose car is due for service. The proactive contacting of customers and offering them an opportunity to have their vehicle serviced at the dealership will greatly increase the chance of getting that customer's business so that the customer does not go to the many outside sources capable of performing the same services that the dealerships provide to their customers. The dealerships can also expect a lower cost associated with the system. Generally, dealerships would have to have a person dedicated to analyzing records in determining the people to be called and for what reasons they should be called. That person and possibly more would have to spend time making the phone calls which in essence ties up many of the dealerships most valuable and expensive resources, its people. The dealership communication system 11 according to the present invention will be configured with a set of dealership specific parameters that will allow it to automatically interact with the dealership system to get the appropriate people to call, and automatically call them with no employee intervention. Therefore, the dealership will be capable of generating new business, saving money and better utilizes its employees for more profitable endeavors.

The dealership communication system 11 will also improve customer satisfaction in numerous ways. One such way is that customers will embrace the ease of use of the speech recognition system because it will reduce the amount of time that a customer spends on the phone. Second, the dealership communication system will provide dealers with an opportunity to stay in touch with the customers and remind them of upcoming service appointments in a simple way without increased costs or time consuming labor. Also the dealership communication system will be capable of measuring customer satisfaction via easy to use speech recognition dialog that can conduct customer satisfaction surveys over the phone. It has been shown that customer satisfaction surveys that are sent by mail have a very low percentage of actually being returned and filled out by the customers, however customer satisfaction surveys performed via the phone are generally more likely to be completed. This also provides immediate feedback to the dealership which can instantly adjust its business model to more appropriately reflect the needs of its customers thus increasing sales and profits.

The dealership communication system 11 includes a plurality of unique features for a dealership. Some of these features are speech recognition which will ensure all customer interaction with the dealership communication system 11 is done via automatic speech recognition. Generally, customers greatly prefer the ease of use of automatic speech recognition systems over touch tone systems. These automatic speech recognition systems are generally easier to use within a variety of environments. These systems also have specific dialogs that are designed to lead customers to very simple responses that require no interaction other than talking. With the increased user satisfaction of automatic speech recognition systems many more customers will accomplish their tasks within the system and not opt out to an advisor or hang up on the dealership all together.

One feature of the integrated communication system is a speech-enabled auto attendant 120. This feature allows the system to answer all incoming phone calls, and utilizing a simple dialog, connects callers to the person or department that they wish to speak with. Using a simple configuration screen to enter names and extensions, the system utilizes the existing private branch exchange (PBX) phone configuration to transfer calls. This minimizes setup time and expense. One novel feature of the auto attendant is the ability to automatically split names. If “Jon Smith” is entered as an extension in the system, it will recognize “Jon Smith”, “Jon”, and “Smith” as three valid ways of expressing that name. This benefits the customer if they only know part of someone's name. Another novel feature of the auto attendant is the ability to handle similar names. If there is an extension of “Jon Smith”, and another extension of “John Sanders”, the system will recognize that “Jon” and “John” sound exactly the same when spoken. When a caller says “Jon”, the system will prompt them that it has more than one possible match, and will list them for the user to select the correct name. Another novel feature of the auto attendant is its extensibility architecture. The system is built such that we can plug in new modules with a minimum of configuration. The system can be configured to transfer a caller to an extension or a module for a particular name. If it is configured as an extension, a phone-based transfer occurs, and the caller speaks to a person. If it is configured as a module, control is turned over to another speech-based dialog. One example is for department-based functionality, such as the service department. A service module could ask the user if they want to schedule an appointment, check parts availability, etc. This leads to further cost savings and customer satisfaction improvements.

Another feature of the dealership communication system is the appointment/missed appointment reminder system. This portion of the dealership communication system 11 will call customers at predetermined times prior to their scheduled appointments to remind them of their service appointments or the like. The customer is then able to either confirm the appointment or if unable to confirm the appointment, the system will offer them an opportunity to reschedule the appointment at that time, all done via speech recognition and with no touch tone systems being used. The system can also follow up with customers who miss an appointment by having the system, at predetermined intervals after the missed appointment, call and offer to reschedule the appointment or provide other services. This type of system will increase the revenue of the dealership by ensuring that scheduled appointments are completed and by re-contacting missed appointments to prevent the business from going elsewhere thus rescheduling the business for later use by the dealership. It will also lower the cost of the dealership by automatically calling and freeing up employees for more valuable tasks within the dealership environment. It will also ensure a more accurate schedule for dealership mechanics and the like which thus improves efficiency of the service department of the dealerships.

The dealership communication system 11 also will feature an automated scheduling feature. This feature can either integrate with the dealership management system in real time, or it can schedule independently without automatic integration. The system will be able to schedule service appointments with either no employee intervention, or minimal interaction by an employee. This will lower costs and free up employees for more valuable tasks while also improving customer service by allowing the customer to schedule service at any time even when the dealership is not open.

The dealership communication system 11 also includes a recall service bulletin notification feature. This will allow a customer to be contacted when a recall or service bulletin is announced by the automotive manufacturer. The dealer communication system 11 will automatically call the effected customers either at the time of the recall or when the parts to correct the recall have arrived at the dealership. The system is also capable of offering them an opportunity to schedule service in conjunction with the recall notice. This will lead to a competitive advantage of lower costs by freeing up employees from their valuable task and increase the revenue by proactively calling customers to schedule service in addition to the recall being fixed. It will also improve customer service by notifying customers at the earliest opportunity that their cars can be serviced and the recall problem fixed.

The dealership communication system 11 also features customer satisfaction surveys that may be instituted at the conclusion of dealer specified transactions such as car purchases, service, or other activity dealing with the dealership. The customer satisfaction system will call the customer with a transaction specific survey, the system then will take that information and report it or document it into specific files for the dealership to use for cost analysis and business analysis. This analysis will then allow the dealership to correct business models and cost models with reference to specific customer complaints and other customer information. The use of the customer satisfaction surveys will improve survey completion rate while also providing more accurate survey results. The customer satisfaction survey conducted via the phone will give a more accurate portrayal of the dealers customer satisfaction score and let them focus on the errors that need attention hence leading to consistent improvement in the service and increase business and profit.

The dealership communication system 11 also is capable of being used for customer mining which will allow a dealer to reach out to customers who have not been seen in a predetermined amount of time or customers whose cars are due for service according to maintenance schedules. It will be capable of calling these customers based on a set of dealership defined parameters, such as length of time since their last service, maintenance schedules, number of months since car has been purchased or leased, etc., and offer customers the opportunity to schedule an appointment. This customer mining will allow the dealerships to increase revenue by actively pursuing additional business with existing customers.

The dealership communication system also is capable of performing parts notification such that the system can automatically notify customers when their special order parts arrive to the dealership and offer them an opportunity to schedule an appointment to have such parts installed by the mechanics of the dealership's service center. This parts communication system will improve customer satisfaction by notifying the customers at the earliest possible time that their parts are in and that they are able to schedule an appointment if necessary to install such parts. As noted all of these features of the dealership communication system all improve the efficiency and profitability of the dealership by freeing up employees who in prior art systems would be needed to make the phone calls or enter specific point of date contact information. The present invention of the dealership communication system is configured in a one time set up and then the dealership communication system will operate seamlessly with minimal employee interaction in the future.

FIG. 1 shows an overall architectural layout of the dealership communication system according to the present invention. The dealership will typically have existing software such as a dealer management system (DMS) that contains customer information, schedule information, maintenance schedules, etc. This information will reside on a dealership management server that the dealership may or may not already have 10. Two other servers will be necessary to comprise the dealer communication system 11 according to the present invention. These servers may reside on one or more physical servers depending on the demand placed on the system. The notification server 12 will communicate with the dealership management server 10. The notification server 12 will include the voice user interface 38 and administration and reporting interfaces for the dealership communication system. A Microsoft speech server 14 will be the other server necessary for the dealer communication system 11. The Microsoft speech server 14 will contain the Microsoft software used to communicate with the phone system 18 and process the inbound and outbound speech for the phone system 18. This technology is enabling technology for the dealership communication system 11. In one embodiment contemplated the Microsoft speech server 14 will include a dialogic telephony card 16 that will create the physical connection between the phone system 18 and the dealership communication system according to the present invention. In one embodiment shown an Intel dialogic telephony card is the telephony card of choice. It should be noted that any other type of operating systems, speech systems, software, hardware servers or telephony cards may be used and that the system is capable of communicating with analog or digital systems. All of these systems will reside entirely behind the dealerships firewall 22 and do not require any additional ports to be opened to the communication system. The customers will be connected to the dealership communication system 11 via a customer telephone 20 or customer mobile phone which will then via the PSTN enter the central office or ISDN phone lines and connect with the telephone phone system 18 of the dealership and then directly to the Microsoft speech server 14 via the telephony card 16 thus allowing for speech recognition to occur between the customers, remote from the dealership and with the internal components of the dealership communication system 11. It should be noted that any other number of servers may be used in the dealership communication system 11 depending on the demand that will be placed on the servers and the expected demand by the dealership for such services.

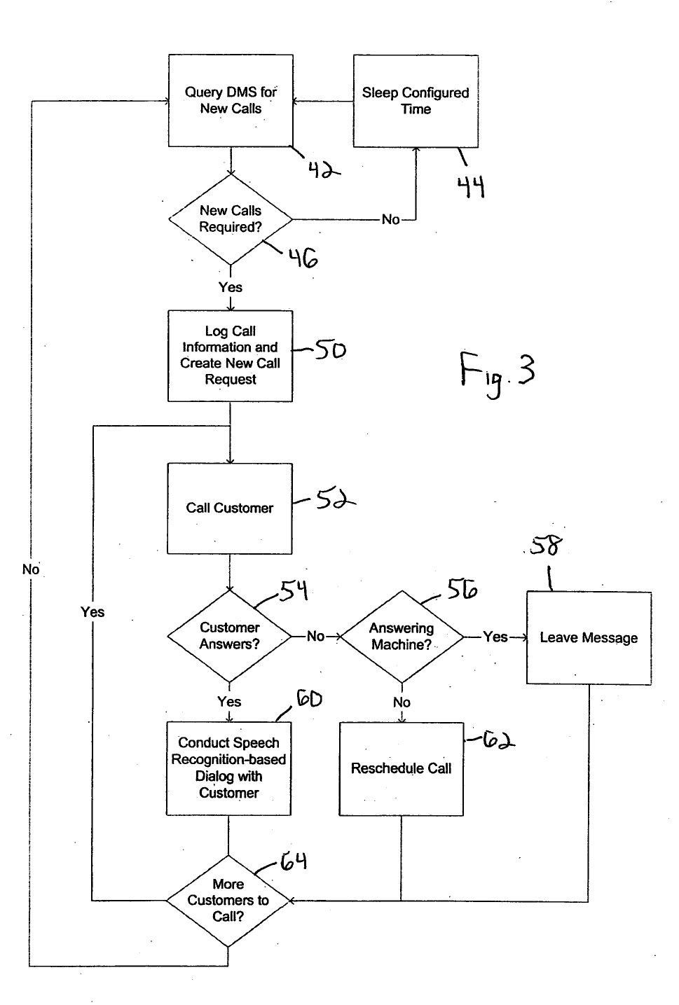

FIG. 2 shows and represents the main logical components of the three systems described above. FIG. 2 also shows the interconnections between the dealer management server 10, the notification server 12, and the Microsoft speech server 14. The dealership management server 10 will maintain and update either additions, subtractions or other editing to the customer data 24, service records 26, and scheduling data 28 for the dealership and its customers, suppliers and employees. It should be noted that other information may also be stored on the dealership management server 10 depending on the specific needs of the dealership and the sophistication of their system. One contemplated dealership communication system according to the present invention during initialization will load configuration information that will specify what the name of the dealership is, what its hours are, where the dealership management server system 10 is located, how often such system is to be polled for new information, any updates to the information, any new information being added within a predetermined time frame, etc. After the dealership communication system is initialized the dealership communication system will via the notification server 12 poll the various dealership management server 10 data sources for information that provide it with information on whether or not it needs to schedule new notifications via the dealership management server monitor service 34 within the notification server 12. The notification server 12 will then make requests via the telephony coordinator 36 for a new call, passing any of the necessary information such as the type of call to be made such as an appointment reminder, special order parts, recall notice, and who to call along with what number to call and what time to make such a call. The telephony coordinator 36 will then interact with the Microsoft speech server 14 to connect the call via the Microsoft speech server processes 40. After the call is connected the Microsoft speech server 14 will interact and transfer data electronically with the voice user interface 38 located on the notification server port 12. This will enable the Microsoft speech server to conduct the call in the language chosen by the user. During the call, information such as call tracking information will be stored by the notification server 12 in a call tracking data file 32. This information will be stored throughout all processes thus enabling the dealership to track all information regarding the functionality of the dealership communication system and the information being retrieved by such system. The dealership management server monitor service 34 will also be connected to the system configuration data file located on the notification server 12 which will hold all of the configuration parameters for the dealership as described above. The Microsoft speech server 14 will be connected to the phone system 18 of the dealership and will allow for seamless automatic voice recognition phone calls to be made from the dealership without employee intervention other than initial setup of the dealership communication system and any inputting of any new customer information upon initial sale or service at the dealership.

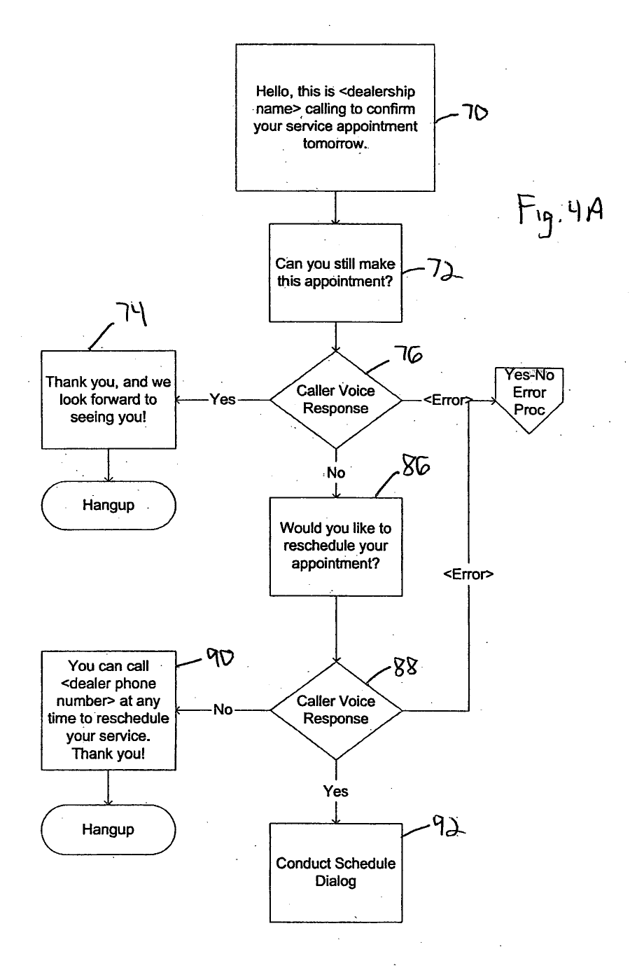

FIG. 3 shows one embodiment of a high level outbound call flow according to the dealership communication system of the present invention. As shown in FIG. 3 the dealership communication system 11 has a specific methodology it will follow. This methodology in the embodiment shown will contact customers without human interaction. In block 42 of the methodology the notification server 12 via its DMS monitor service 34 will query the dealership management server 10 according to predetermined parameters in the notification server system configuration data file 30. The query will ask the dealership management server 10 if any new calls are to be made. In block 46 if no new calls are to be made to customers, suppliers, or employees, the dealership communication system will enter block 44 and enter a sleep configured time mode which is a predetermined amount of time that the dealership communication system will be dormant. After the predetermined amount of time passes the methodology will then once again enter block 42 and query the dealership management server 10 to determine if any new calls are to be made at that time. If in block 46 new calls are required to be made, the methodology will enter block 50 and log call information and create a new call request. This new notification is requested and the call is submitted for processing. Next the methodology will enter block 52 and the customer will be called via the telephony coordinator 36 of the notification server 12 and the Microsoft speech server processes 40 along with the phone system 18. The methodology will then enter block 54 and if the customer does not answer the methodology will enter block 56 and determine if an answering machine picks up the call. If the answering machine picks up the call, the methodology will enter block 58 and leave a predetermined message telling the consumer specific information about the appointment, availability of parts, or to call the dealership at a specific number upon receiving the message.

It should be noted that an answering machine detection relies primarily on the underlying software. Due to the older technology that many of the existing phone networks are built on, there is no completely reliable method to determine if an answering machine or person answered the phone. Hence, there exists the possibility that the underlying software misidentifies the answering entity. This can lead to problems such as transferring an answering machine to an employee, and an undesirable message being left on the customer's answering machine. To minimize the possibility of this occurring, the system implements additional logic wherein if, after asking the first prompt, we receive silence, we treat that call as an answering machine, even though the underlying software identified it as a human voice.

Then the methodology after the leaving the message will enter block 64 to determine if more customers are to be called at the current time. If more customers are to be called, the methodology will return to block 52 and call the next customer to be called. If the customer does not answer the phone, no answering machine picks up, the line is busy, or is hung up, the system will enter block 62 of the methodology and reschedule the call to be attempted again at a predetermined time according to the defined parameters of the system configuration data. The methodology would then exit block 62 and enter block 64 to determine if more customers need to be called at the current time. If in block 54 of the methodology a customer does answer the telephone, the methodology will enter block 60 where the dealership communication system will proceed with the dialog and log or save any information necessary and send updates to the dealership management server 10 if and when information is changed, things are rescheduled, or other information is passed on from the customer to the dealership. The dialog will be conducted via speech recognition based systems. After the call is concluded the methodology will enter block 64 to determine if more customers are to be called. If more customers are to be called, the methodology will return to block 52 and the call pattern will resume. The methodology will continue in this manner as long as there are new calls to make and the dealership communication system is operating in an appropriate time to make calls. It should be noted that the dealership communication system is capable of being programmed to any number of parameters such as if there are notification requests in the queue at 2:00 a.m., it will not make those calls until the next appropriate time to call window opens, which is specified in the configuration stored on the system configuration data file 30 or notification server 12.

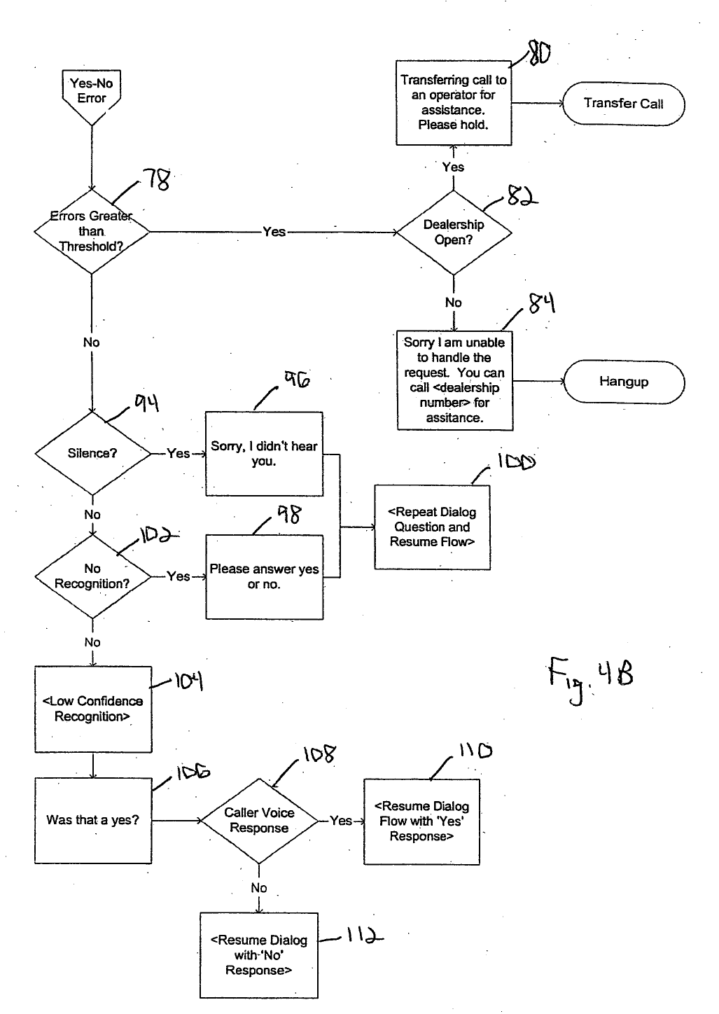

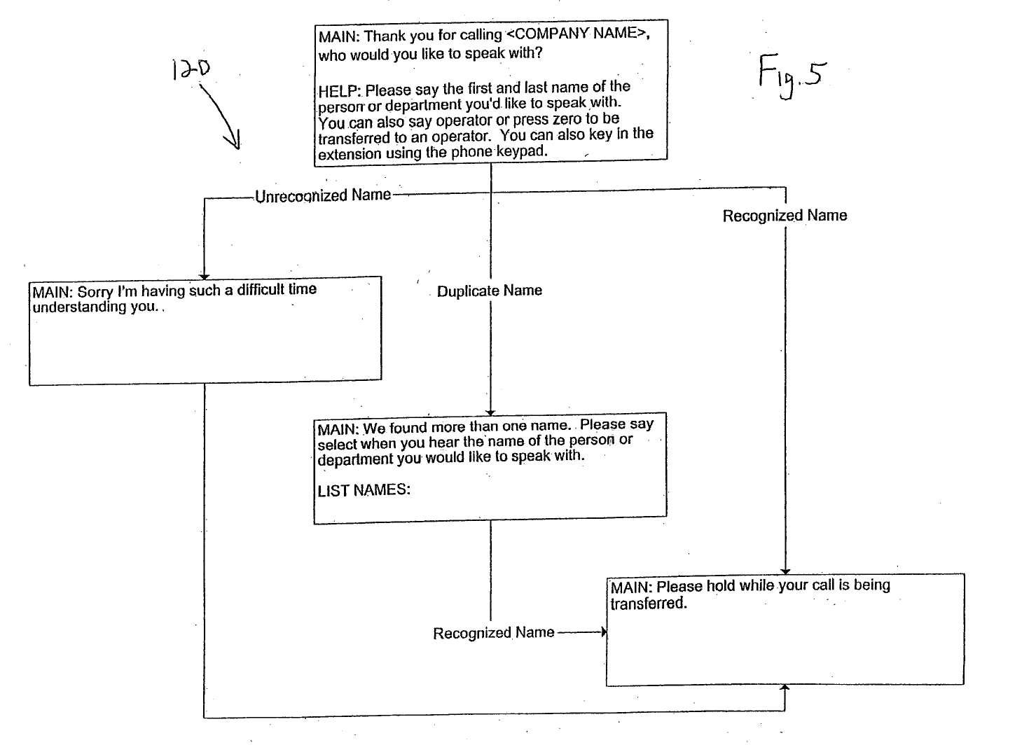

FIG. 4 shows a sample call flow according to the dealership communication system of the present invention. FIG. 4 represents how a simple call would be handled by the dealership communication system and the customer. As noted above, the entire dealership communication system is based on voice recognition, so methodology shown in FIG. 4 documents the questions that the system would ask the caller/customer and typical responses that the user might give. In a situation where the dealership communication system does not recognize what the user says, because the user did not say anything, mumbled, or spoke something that the system just did not understand, the system will follow a predetermined error path. In this error path a configurable threshold for the number of times the system tries to handle an error before it exits the user from the system will be polled. This is to prevent a “downward spiral” where the system, for whatever reason, is simply unable to understand anything the user says. If the dealership is open, according to the configured hours of the dealership which are predetermined, the system will transfer the customer to an operator for assistance. If it is not, it will explain the situation to the customer with a phone number they can call for later for assistance and will disconnect the call automatically.

The sample call flow as shown in FIG. 4 starts in block 70 where the Microsoft speech server 14 via the voice user interface 38 will make the call to the consumer and identify itself as such. The methodology then will enter block 72 and will ask the consumer if it is still possible to make the appointment as arranged. The methodology will then enter block 76 and wait for the caller to respond and if the caller responds with a “yes” the methodology will enter block 74 and thank the consumer for their response and tell them that the dealership looks forward to seeing them at their scheduled appointment time. If the caller responds with a “no” the methodology will enter block 86 and the dealership communication system will offer the customer the opportunity to reschedule their appointment. The methodology will then enter block 88 if the customer does not want to reschedule their appointment and the Microsoft speech server 14 will relay any predetermined message such as “you can call at any time to reschedule your service, thank you” and then end the call. If the caller responds with a yes to the “would you like to reschedule your appointment “box” 88 the methodology will enter block 92 and conduct a scheduled dialog change session with the customer. If in block 76 the dealership communication system detects an error either because the user did not say anything, they mumbled, or the system just did not understand it, the methodology will enter block 78 and determine if the errors that have occurred to this point are greater than a predetermined threshold. If the errors are greater than the predetermined threshold the methodology will enter block 82 and determine if the dealership is open. If the dealership is open the methodology will enter block 80 and transfer the call to an operator for assistance. If the dealership is not open, the methodology will enter block 84 and transmit a message to the customer telling them that the dealership is sorry they were unable to handle their request, but they can call the dealership at a later time for assistance. If in block 78 the errors are not greater than a predetermined threshold for the dealership communication system, the methodology will enter block 94 and determine if the response from the initial call was silence. If the response was silence, the methodology will enter block 96 and respond “sorry I did not hear you.” Next the methodology will enter block 100 and repeat the dialog question and resume flow of the call from block 72. If in block 94 it was determined that there was no silence, but the person mumbled or the system just did not understand it, the methodology will enter block 102 and determine if the system recognized what was said. If the Microsoft speech server processes 40 do not recognize what was said by the person or customer, the methodology will enter block 98 and tell them they are sorry that they did not understand and then repeat the dialog question and resume flow in block 100 which will return the methodology back to block 72 to begin the process anew. If in block 102 the Microsoft server process 40 does not have recognition, it will enter block 104 and label the recognition as low confidence recognition. Then the methodology will enter block 106 and ask a question such as “was that a yes?”, and then the methodology will enter block 108 and if the caller responds “yes” that then the methodology will enter block 110 and resume the dialog flow with a yes response thus entering block 74 thereafter. If the caller voice response is a no, the methodology will enter block 112 and resume the dialog flow with the no response thus entering block 86 of the methodology. Therefore, this describes and shows a typical call that can be made by the dealership communication system without the intervention of any human employee other than initial setup of the dealership communication system upon purchase.

It should also be noted that any type of computer can be used for any of the servers as described above along with any type of telephone exchange system, voice unit interface, speech recognition and text to speech converter systems, any type known may be used along with any known software in the above-identified business communication system.

As noted above, the Figures and description have been for a dealership communication system, however it should be noted that the dealership communication system of the present invention can be adjusted and designed to operate in any number of businesses that have contact with suppliers, customers, and employees at any level. Therefore, the above invention can be used for systems other than that of a dealership for automotive vehicles.

While it may be apparent that the preferred embodiment of the invention disclosed are well calculated to fill benefits, objects or advantages of the present invention, it should be appreciated that the invention is susceptible to modification, variations and change without departing from their proper scope of the invention as shown.

1. A speech based notification system, said system including:
a data server;
a notification server in communication with said data server;
a speech server in communication with said notification server; and
a phone system in communication with said speech server.

2. The system of claim 1 wherein said data server having customer data, service records, and scheduling data stored thereon.

3. The system of claim 1 wherein said notification server monitors said data server and communicates via a telephony coordinator and a voice user interface with said speech server.

4. The system of claim 3 wherein said monitoring, telephony coordinator and voice user interface are all in communication with system configuration data and call tracking data stored on said notification server.

5. The system of claim 4 wherein said telephony coordinator and voice user interface communicate with speech server processes, said speech server processes communicate with said phone system.

6. The system of claim 1 wherein said phone system is connected to phone lines, networks or wireless systems.

7. A method of controlling a speech based communication system, said method including the steps of:
initializing the communication system;
polling a first server for predetermined data or data sources;
requesting a new call via a telephony coordinator;
connecting said new call via a speech server;
enabling said speech server to conduct said new call;
transferring predetermined information to said speech server during said new call;
disconnecting said new call upon completion thereof, and
determining if other new calls are pending.

8. The method of claim 7 wherein said step of initializing will specify name of business, hours of operation, location of said first server, time for polling and updates to correct information.

9. The method of claim 7 wherein said step of polling includes checking said data for information on whether to schedule notifications via a monitor service on a second server.

10. The method of claim 9 wherein said step of requesting is placed through said second server identifying type of call, who to call, what number to call and what time to call.

11. The method of claim 9 wherein said telephony coordinator interacts with said speech server via predetermined processes on said speech server.

12. The method of claim 9 wherein said step of transferring includes call tracking information and system configuration data on said second server.

13. The method of claim 12 wherein said first server is a management data system server.

14. The method of claim 12 wherein said second server is a notification server.

15. A method of controlling a dealership notification system, said method including the steps of:
querying a dealership management server via a monitor service on a notification server;
determining if a call is to be made;
calling a predetermined customer;
determining if said customer answers said call;
conducting dialog with said customer via a speech server; and
determining if other customers are to be called.

16. The method of claim 15 further including the steps of logging all information and creating a new call request.

17. The method of claim 15 further including the step of entering a predetermined sleep time mode if no new calls are to be made.

18. The method of claim 15 further including the step of determining if an answering machine or other electronic device answers said call.

19. The method of claim 18 further including the step of leaving a message if said answering machine answers or rescheduling said call if no answer to said call.

20. The method of claim 15 wherein said step of conducting dialog includes using a telephony coordinator on said notification server to communicate with speech server processes on said speech server, said speech server communicates with a phone system.

21. The method of claim 15 further including the step of answering incoming calls with an auto attendant system.

22. The method of claim 21 further including the steps of recognizing and spliting names into a predetermined number of extensions and recognizing and processing similar names received by said auto attendant system.

23. The method of claim 21 wherein said auto attendant system having an extensible architecture capable of receiving new modules.

24. The method of claim 18 further including the step of handling silence after a first prompt for said call as an answering machine answering said call.
